(19) United States
(12) Patent Application Publication
(10) Pub. No.: US 2019/0386346 A1
(43) Pub. Date: Dec. 19, 2019

(54) AQUEOUS ELECTROLYTE SOLUTION, AND AQUEOUS POTASSIUM-ION BATTERY

(71) Applicant: TOYOTA JIDOSHA KABUSHIKI KAISHA, Toyota-shi (JP)

(72) Inventor: Hiroshi SUYAMA, Mishima-shi (JP)

(73) Assignee: TOYOTA JIDOSHA KABUSHIKI KAISHA, Toyota-shi (JP)

(21) Appl. No.: 16/392,691

(22) Filed: Apr. 24, 2019

(30) Foreign Application Priority Data
Jun. 18, 2018 (JP) 2018-115463

(51) Int. Cl. H01M 10/26; H01M 4/66; H01M 4/36; H01M 4/62

(52) U.S. Cl. CPC H01M 10/26; H01M 4/661; H01M 2004/027; H01M 4/628; H01M 2300/0014; H01M 4/366

(57) ABSTRACT

To suppress electrolysis of an aqueous electrolyte solution on a surface of an anode when an aqueous potassium-ion battery is charged/discharged, in the aqueous electrolyte solution, potassium pyrophosphate is dissolved in water so that its concentration per kilogram of the water is no less than 2 mol. It is believed that thereby, a pyrophosphate ion is decomposed on the surface of the anode when the battery is charged/discharged, and a coating is formed on a portion of a high work function on the surface of the anode. As a result, direct contact between the aqueous electrolyte solution and the surface of the anode is suppressed, and electrolysis of the aqueous electrolyte solution on the surface of the anode is suppressed when the battery is charged/discharged.

### FIELD

The present application discloses, for example, an aqueous electrolyte solution used for an aqueous potassium-ion battery.

### BACKGROUND

A nonaqueous battery that includes a flammable nonaqueous electrolyte solution is equipped with a lot of members for safety measures, and as a result, an energy density per volume as a whole of the battery is low, which is problematic. In contrast, an aqueous battery that includes a nonflammable aqueous electrolyte solution does not need safety measures as described above, and thus has various advantages such as a high energy density per volume. However, a conventional aqueous electrolyte solution has a problem of a narrow potential window, which restricts usable active materials etc.

As one means for solving the problem that an aqueous electrolyte solution has, Non Patent Literature 1 and Patent Literature 1 disclose that a range of a potential window of an aqueous electrolyte solution is expanded by dissolving a salt of lithium and an imide in the aqueous electrolyte solution so as to have a high concentration. In Non Patent Literature 1, charge/discharge of an aqueous lithium ion secondary battery is confirmed as using lithium titanate, which is difficult to be used as an anode active material in a conventional aqueous lithium ion battery, as an anode active material, owing to the use of an aqueous electrolyte solution with a high concentration as described above.

### CITATION LIST

### Patent Literature

Patent Literature 1: JP 2017-126500 A

### Non Patent Literature

Non Patent Literature 1: Yuki Yamada et al., “Hydrate-melt electrolytes for high-energy-density aqueous batteries”, NATURE ENERGY (26 Aug. 2016)

### SUMMARY

### Technical Problem

The use of the aqueous electrolyte solutions disclosed in Non Patent Literature 1 and Patent Literature 1 is restricted to a lithium ion battery. Lithium resources are unevenly distributed, which lends a high probability of high costs and social unrest caused by improved demand. In this point, it is important to develop an aqueous battery that uses a carrier ion other than a lithium ion (such as potassium ion). Here, an aqueous potassium-ion battery also has a problem of a narrow potential window of an aqueous electrolyte solution on the reduction side, which leads to easy electrolysis of the aqueous electrolyte solution on a surface of an anode as the battery is charged/discharged.

### Solution to Problem

The present application discloses, as one means for solving the problem, an aqueous electrolyte solution that is used for an aqueous potassium-ion battery, the aqueous electrolyte solution comprising: water; and potassium pyrophosphate that is dissolved in the water so that a concentration thereof per kilogram of the water is no less than 2 mol.

In the aqueous electrolyte solution of this disclosure, “potassium pyrophosphate that is dissolved” does not have to be ionized to form a potassium ion and a pyrophosphate ion. In the aqueous electrolyte solution of this disclosure, “potassium pyrophosphate that is dissolved” may exist as ions such as K⁺, P₂O₇⁴⁻, KP₂O₇³⁻, K₂P₂O₇²⁻ and K₃P₂O₇⁻, or as associations thereof.

In the aqueous electrolyte solution of this disclosure, “potassium pyrophosphate that is dissolved” does not have to be derived from a salt of potassium and pyrophosphoric acid (K₄P₂O₇) (obtained by adding K₄P₂O₇ to water). For example, a potassium ion source (such as KOH and CH₃COOK) and a pyrophosphate ion source (such as H₄P₂O₇) are separately added to and dissolved in water, and as a result, ions or associations as described above are formed in the water, which also falls under the aqueous electrolyte solution of this disclosure.

In the aqueous electrolyte solution, the concentration of “potassium pyrophosphate that is dissolved” can be found as follows: for example, elements and ions contained in the aqueous electrolyte solution are identified by elementary analysis and ion analysis, the concentration of a potassium ion, the concentration of a pyrophosphate ion etc. in the aqueous electrolyte solution are found, and the found concentrations of ions are converted into that of potassium pyrophosphate; alternatively, solvent is removed from the aqueous electrolyte solution, and the solid content is chemically analyzed to be converted into the concentration of potassium pyrophosphate.

In the aqueous electrolyte solution of the present disclosure, the potassium pyrophosphate is preferably dissolved in the water so that the concentration per kilogram of the water is no more than 7 mol.

In the aqueous electrolyte solution of the present disclosure, pH is preferably no more than 13.

The present application discloses, as one means for solving the problem, an aqueous potassium-ion battery comprising: the aqueous electrolyte solution according to the present disclosure; a cathode that is in contact with the aqueous electrolyte solution; and an anode that is in contact with the aqueous electrolyte solution.

In the aqueous potassium-ion battery of the present disclosure, preferably, the anode comprises an anode current collector layer, and a covering layer that is provided for one surface of the anode current collector layer, the surface being on a side where the aqueous electrolyte solution is arranged, and the covering layer contains a carbon material.

In the aqueous potassium-ion battery of the present disclosure, the anode preferably comprises an anode current collector layer that contains Ti.

### Advantageous Effects

When an aqueous potassium-ion battery is composed as using the aqueous electrolyte solution of the present disclosure, electrolysis of the aqueous electrolyte solution on a surface of an anode is suppressed. This is presumed to be according to the mechanism as follows.

According to new findings of the inventor of the present disclosure, an aqueous electrolyte solution is easy to be electrolyzed especially on a portion of a low hydrogen overvoltage, that is, on a portion of a high work function, on a surface of an anode. Thus, making a portion of a high work function on a surface of an anode as small as possible is expected to make it possible to suppress electrolysis of an aqueous electrolyte solution.

In the aqueous electrolyte solution of this disclosure, potassium pyrophosphate is dissolved so as to have a concentration no less than 2 mol/kg. When an aqueous potassium-ion battery is composed as using such an aqueous electrolyte solution, it is believed that a pyrophosphate ion is easy to move to the anode side together with a potassium ion in the aqueous electrolyte solution when the battery is charged, for example. It is believed that thereby, the pyrophosphate ion is decomposed on a portion of a high work function on a surface of an anode, and a coating is formed on the surface of the anode. It is believed that as a result, direct contact between the aqueous electrolyte solution and the portion of a high work function on the surface of the anode is suppressed, and electrolysis of the aqueous electrolyte solution is suppressed.

### BRIEF DESCRIPTION OF DRAWINGS

FIG. 1 is an explanatory schematic view of structure of an aqueous potassium-ion battery 1000;

FIGS. 2A to 2D show properties of aqueous electrolyte solutions according to Example (electrolyte: K₄P₂O₇) and Comparative Example (electrolyte: K₃PO₄): FIG. 2A shows the relationship between the concentrations and specific gravity of the electrolytes, FIG. 2B shows the relationship between the concentrations and ion conductivity of the electrolytes, FIG. 2C shows the relationship between the concentrations and viscosity of the electrolytes, and FIG. 2D shows the relationship between the concentrations and pH of the electrolytes;

FIG. 3 is a cyclic voltammogram of the aqueous electrolyte solution of Example (concentration of K₄P₂O₇: 0.5 mol/kg, 2 mol/kg and 7 mol/kg) on both the oxidation and reduction sides;

FIG. 4 shows the relationship between the concentrations and potential windows of the aqueous electrolyte solutions of Example and Comparative Example;

FIG. 5 is a cyclic voltammogram of the aqueous electrolyte solution of Example (concentration of K₄P₂O₇: 7 mol/kg) and that of Reference Example (concentration of CH₃COOK: 28 mol/kg) on both the oxidation and reduction sides;

FIG. 6 is a cyclic voltammogram of the aqueous electrolyte solution of Example (concentration of K₄P₂O₇: 7 mol/kg) on the reduction side in both cases where Ti was used for a working electrode and where a carbon-coating Ti electrode was used as a working electrode; and

FIG. 7 is a cyclic voltammogram of the aqueous electrolyte solution of Comparative Example (concentration of LiTFSI: 21 mol/kg) on the reduction side in both cases where Ti was used for a working electrode and where a carbon-coating Ti electrode was used as a working electrode.

### DETAILED DESCRIPTION OF EMBODIMENTS

1. Aqueous Electrolyte Solution

A feature of the aqueous electrolyte solution of this disclosure is an aqueous electrolyte solution that is used for an aqueous potassium-ion battery, the aqueous electrolyte solution comprising: water; and potassium pyrophosphate that is dissolved in the water so that a concentration thereof per kilogram of the water is no less than 2 mol.

1.1. Solvent

The aqueous electrolyte solution of this disclosure contains water as solvent. The solvent contains water as the main constituent. That is, no less than 50 mol %, preferably no less than 70 mol %, more preferably no less than 90 mol %, and especially preferably no less than 95 mol % of the solvent that is a constituent of the electrolyte solution is water on the basis of the total mass of the solvent (100 mol %). On the other hand, the upper limit of the proportion of water in the solvent is not specifically limited. The solvent may be constituted of water only.

For example, in view of forming SEI (Solid Electrolyte Interphase) over a surface of an active material, the solvent may contain solvent other than water in addition to water as far as the problem can be solved. Examples of solvent other than water include at least one organic solvent selected from an ether, a carbonate, a nitrile, an alcohol, a ketone, an amine, an amide, a sulfur compound, and a hydrocarbon. Preferably no more than 50 mol %, more preferably no more than 30 mol %, further preferably no more than 10 mol %, and especially preferably no more than 5 mol % of the solvent is solvent other than water on the basis of the total mass of the solvent that is a constituent of the electrolyte solution (100 mol %).

1.2. Electrolyte

An electrolyte is dissolved in the aqueous electrolyte solution of the present disclosure. This electrolyte can dissociate to form a cation and an anion in an electrolyte solution. In the aqueous electrolyte solution of this disclosure, such cation and anion may be close to each other to form an association.

1.2.1. Dissolved Potassium Pyrophosphate

The aqueous electrolyte solution of the present disclosure comprises, as an electrolyte, potassium pyrophosphate that is dissolved in the water so that a concentration thereof per kilogram of the water is no less than 2 mol. In the aqueous electrolyte solution of the present disclosure, the concentration of ions, associations, etc. contained in the electrolyte solution in terms of potassium pyrophosphate may be no less than 2 mol per kilogram of water. This concentration may be no less than 3 mol, and may be no less than 5 mol. The upper limit of this concentration is not specifically limited. In view of suppressing high viscosity, the concentration is preferably no more than 7 mol per kilogram of water. In the aqueous electrolyte solution, “potassium pyrophosphate that is dissolved” may exist as ions such as K⁺, P₂O₇⁴⁻, KP₂O₇³⁻, K₂P₂O₇²⁻ and K₃P₂O₇⁻, or as associations thereof.

The aqueous electrolyte solution of the present disclosure includes a potassium ion as a cation. The concentration of potassium in the aqueous electrolyte solution of the present disclosure is not specifically limited as long as the concentration as “potassium pyrophosphate that is dissolved” is satisfied. The aqueous electrolyte solution of the present disclosure has potassium ion conductivity, and properties suitable for an electrolyte solution for the aqueous potassium-ion battery.

In the aqueous electrolyte solution of the present disclosure, the whole of a potassium ion included in the electrolyte solution does not have to be converted as “potassium pyrophosphate that is dissolved”. That is, in the aqueous electrolyte solution of the present disclosure, a potassium ion of a higher concentration than a concentration that can be converted as potassium pyrophosphate may be included. For example, if a potassium ion source other than K₄P₂O₇ (such as KOH, CH₃COOK and K₃PO₄) is added to and dissolved in water together with K₄P₂O₇ when the aqueous electrolyte solution is produced, a potassium ion of a higher concentration than a concentration that can be converted as potassium pyrophosphate is included in the aqueous electrolyte solution.

In the aqueous electrolyte solution of the present disclosure, other cations may be included as long as the problem can be solved. Examples thereof include alkali metal ions other than a potassium ion, alkaline earth metal ions, and transition metal ions.

The aqueous electrolyte solution of the present disclosure includes a pyrophosphate ion (may exist in a state of bonds with cations like KP₂O₇³⁻, K₂P₂O₇²⁻, K₃P₂O₇⁻ etc. in addition to a state of P₂O₇⁴⁻ as described above) as an anion. The concentration of a pyrophosphate ion etc. in the aqueous electrolyte solution of the present disclosure is not specifically limited as long as the concentration as “potassium pyrophosphate that is dissolved” is satisfied. Since potassium pyrophosphate of no less than 2 mol/kg is dissolved in the aqueous electrolyte solution of the present disclosure as described above, it is believed to be easy that a pyrophosphate ion and a potassium ion are close to each other to form associations. Thus, it is believed that a pyrophosphate ion is easy to move to the anode side as if a pyrophosphate ion were dragged by a potassium ion when the battery is charged, for example. A pyrophosphate ion that reaches an anode is believed to decompose on a portion of a high work function on a surface of the anode, to form a coating on the surface of the anode. As a result, direct contact between the aqueous electrolyte solution and the portion of a high work function on the surface of the anode is suppressed and electrolysis of the aqueous electrolyte solution is suppressed.

In the aqueous electrolyte solution of the present disclosure, the whole of a pyrophosphate ion included in the electrolyte solution does not have to be converted as “potassium pyrophosphate that is dissolved”. That is, in the aqueous electrolyte solution of the present disclosure, a pyrophosphate ion of a higher concentration than a concentration that can be converted as potassium pyrophosphate may be included. For example, if a pyrophosphate ion source other than K₄P₂O₇ (such as H₄P₂O₇) is added to and dissolved in water together with K₄P₂O₇ when the aqueous electrolyte solution is produced, a pyrophosphate ion of a higher concentration than a concentration that can be converted as potassium pyrophosphate is included in the aqueous electrolyte solution.

In the aqueous electrolyte solution of the present disclosure, other anions may be included as long as the problem can be solved. Examples thereof include anions derived from other electrolytes that will be described later.

1.2.2. Other Constituents

The aqueous electrolyte solution of the present disclosure may contain other electrolytes. Examples thereof include KPF₆, KBF₄, K₂SO₄, KNO₃, CH₃COOK, (CF₃SO₂)₂NK, KCF₃SO₃, (FSO₂)₂NK, K₂HPO₄ and KH₂PO₄. The content of other electrolytes is preferably no more than 50 mol %, more preferably no more than 30 mol %, and further preferably no more than 10 mol %, on the basis of the total mass of electrolytes dissolved in the electrolyte solution (100 mol %).

In the aqueous electrolyte solution of the present disclosure, acid, a hydroxide, etc. for adjusting pH of the aqueous electrolyte solution may be contained in addition to electrolytes as described above. Various additives may be also included therein.

1.3. pH

pH of the aqueous electrolyte solution of the present disclosure is not specifically limited as long as the concentration of “potassium pyrophosphate that is dissolved” can be maintained. Too high pH may lead to a narrow potential window of the aqueous electrolyte solution on the oxidation side. In this point, pH of the aqueous electrolyte solution is preferably no more than 13, and more preferably no more than 12. The lower limit of pH is preferably no less than 3, more preferably no less than 4, further preferably no less than 6, and especially preferably no less than 7.

2. Aqueous Potassium-Ion Battery

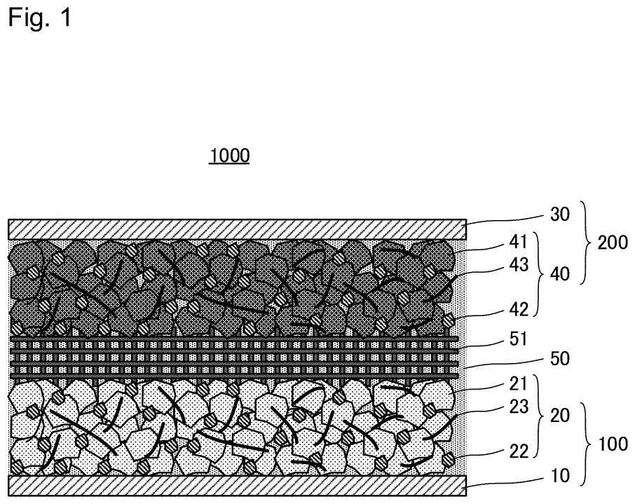

FIG. 1 schematically shows structure of an aqueous potassium-ion battery 1000. As shown in FIG. 1, the aqueous potassium-ion battery 1000 includes an aqueous electrolyte solution 50, a cathode 100 that is in contact with the aqueous electrolyte solution 50, and an anode 200 that is in contact with the aqueous electrolyte solution 50. Here, one feature of the aqueous potassium-ion battery 1000 is to include the aqueous electrolyte solution of this disclosure as the aqueous electrolyte solution 50. The aqueous potassium-ion battery 1000 of the present disclosure can function as a secondary battery.

2.1. Cathode

Any known one as a cathode for an aqueous potassium-ion battery can be employed for the cathode 100. Specifically, the cathode 100 preferably includes a cathode current collector layer 10, and preferably includes a cathode active material layer 20 containing a cathode active material 21 and being in contact with the cathode current collector layer 10.

2.1.1. Cathode Current Collector Layer

A known metal that can be used as a cathode current collector layer of an aqueous potassium-ion battery can be used for the cathode current collector layer 10. Examples thereof include metallic material containing at least one element selected from the group consisting of Cu, Ni, Al, V, Au, Pt, Mg, Fe, Ti, Pb, Co, Cr, Zn, Ge, In, Sn and Zr. The form of the cathode current collector layer 10 is not specifically restricted, and may have any form such as foil, mesh, and a porous form. The cathode current collector layer 10 may be one, on a surface of a base material of which metal as described above is deposited, or the surface of the base material of which is plated with metal as described above.

2.1.2. Cathode Active Material Layer

The cathode active material layer 20 contains the cathode active material 21. The cathode active material layer 20 may contain a conductive additive 22 and a binder 23 in addition to the cathode active material 21.

Any cathode active material for an aqueous potassium-ion battery can be employed for the cathode active material 21. Needless to say, the cathode active material 21 has a potential higher than that of an anode active material 41 described later, and is properly selected in view of potential windows of the aqueous electrolyte solution 50. For example, a cathode active material containing a K element is preferable. Specific preferred examples of the cathode active material 21 include oxides and polyanions which contain a K element. More specific examples thereof include potassium-cobalt composite oxides (such as KCoO₂), potassium-nickel composite oxides (such as KNiO₂), potassium-nickel-titanium composite oxides (such as KNi_{1/2}Ti_{1/2}O₂), potassium-nickel-manganese composite oxides (such as KNi_{1/2}Mn_{1/2}O₂ and KNi_{1/3}Mn_{2/3}O₂), potassium-manganese composite oxides (such as KMnO₂ and KMn₂O₄), potassium-iron-manganese composite oxides (such as K_{2/3}Fe_{1/3}Mn_{2/3}O₂), potassium-nickel-cobalt-manganese composite oxides (such as KNi_{1/3}Co_{1/3}Mn_{1/3}O₂), potassium-iron composite oxides (such as KFeO₂), potassium-chromium composite oxides (such as KCrO₂), potassium-iron-phosphate compounds (such as KFePO₄), potassium-manganese-phosphate compounds (such as KMnPO₄), potassium-cobalt-phosphate compounds (KCoPO₄), Prussian blue, and solid solutions and compounds of nonstoichiometric compositions thereof. Alternatively, potassium titanate, TiO₂, LiTi₂(PO₄)₃, sulfur (S), or the like which shows a nobler charge/discharge potential compared to an anode active material described later can be used as well. One of them may be used individually, or two or more of them may be mixed to be used as the cathode active material 21.

The shape of the cathode active material 21 is not specifically restricted. A preferred example thereof is a particulate shape. When the cathode active material 21 is in the form of a particle, the primary particle size thereof is preferably 1 nm to 100 μm. The lower limit is more preferably no less than 5 nm, further preferably no less than 10 nm, and especially preferably no less than 50 nm; and the upper limit is more preferably no more than 30 μm, and further preferably no more than 10 μm. Primary particles of the cathode active material 21 one another may assemble to form a secondary particle. In this case, the secondary particle size is not specifically restricted, and is usually 0.5 μm to 50 μm. The lower limit is preferably no less than 1 μm, and the upper limit is preferably no more than 20 μm. The particle sizes of the cathode active material 21 within these ranges make it possible to obtain the cathode active material layer 20 further superior in ion conductivity and electron conductivity.

The amount of the cathode active material 21 contained in the cathode active material layer 20 is not specifically restricted. For example, on the basis of the whole of the cathode active material layer 20 (100 mass %), the content of the cathode active material 21 is preferably no less than 20 mass %, more preferably no less than 40 mass %, further preferably no less than 60 mass %, and especially preferably no less than 70 mass %. The upper limit is not specifically restricted, and is preferably no more than 99 mass %, more preferably no more than 97 mass %, and further preferably no more than 95 mass %. The content of the cathode active material 21 within this range makes it possible to obtain the cathode active material layer 20 further superior in ion conductivity and electron conductivity.

The cathode active material layer 20 preferably contains the conductive additive 22 and the binder 23 in addition to the cathode active material 21. The conductive additive 22 and the binder 23 are not specifically limited.

Any conductive additive used in an aqueous potassium-ion battery can be employed for the conductive additive 22. Specific examples thereof include carbon materials. For example, a carbon material selected from Ketjen black (KB), vapor grown carbon fiber (VGCF), acetylene black (AB), a carbon nanotube (CNT), a carbon nanofiber (CNF), carbon black, coke, and graphite is preferable. Or, a metallic material that can bear an environment where the battery is used may be used. One of them may be used individually, or two or more of them may be mixed to be used as the conductive additive 22. Any shape such as powder and fiber can be employed for the conductive additive 22. The amount of the conductive additive 22 contained in the cathode active material layer 20 is not specifically restricted. For example, the content of the conductive additive 22 is preferably no less than 0.1 mass %, more preferably no less than 0.5 mass %, and further preferably no less than 1 mass %, on the basis of the whole of the cathode active material layer 20 (100 mass %). The upper limit is not specifically restricted, and preferably no more than 50 mass %, more preferably no more than 30 mass %, and further preferably no more than 10 mass %. The content of the conductive additive 22 within this range makes it possible to obtain the cathode active material layer 20 further superior in ion conductivity and electron conductivity.

Any binder used in an aqueous potassium-ion battery can be employed for the binder 23. Examples thereof include styrene-butadiene rubber (SBR), carboxymethyl cellulose (CMC), acrylonitrile-butadiene rubber (ABR), butadiene rubber (BR), polyvinylidene fluoride (PVDF), and polytetrafluoroethylene (PTFE). One of them may be used individually, or two or more of them may be mixed to be used as the binder 23. The amount of the binder 23 contained in the cathode active material layer 20 is not specifically restricted. For example, the content of the binder 23 is preferably no less than 0.1 mass %, more preferably no less than 0.5 mass %, and further preferably no less than 1 mass %, on the basis of the whole of the cathode active material layer 20 (100 mass %). The upper limit is not specifically restricted, and is preferably no more than 50 mass %, more preferably no more than 30 mass %, and further preferably no more than 10 mass %. The content of the binder 23 within this range makes it possible to properly bind the cathode active material 21 etc., and to obtain the cathode active material layer 20 further superior in ion conductivity and electron conductivity.

The thickness of the cathode active material layer 20 is not specifically restricted, and for example, is preferably 0.1 μm to 1 mm, and more preferably 1 μm to 100 μm.

2.2. Anode

Any known one as an anode for an aqueous potassium-ion battery can be employed for the anode 200. Specifically, the anode 200 preferably includes an anode current collector layer 30, and preferably includes an anode active material layer 40 containing the anode active material 41 and being in contact with the anode current collector layer 30.

2.2.1. Anode Current Collector Layer

The anode current collector layer 30 may be constituted of a known metal that can be used as an anode current collector layer of an aqueous potassium-ion battery. Examples thereof include metallic material containing at least one element selected from the group consisting of Cu, Ni, Al, V, Au, Pt, Mg, Fe, Ti, Pb, Co, Cr, Zn, Ge, In, Sn and Zr. Specifically, the anode current collector layer 30 preferably contains at least one selected from the group consisting of Al, Ti, Pb, Zn, Sn, Mg, Zr and In. In view of, for example, stability in the aqueous electrolyte solution, the anode current collector layer 30 more preferably contains at least one selected from the group consisting of Ti, Pb, Zn, Sn, Mg, Zr and In, and especially preferably contains Ti. Al, Ti, Pb, Zn, Sn, Mg, Zr and In all have low work functions, and it is believed that even if they are in contact with the aqueous electrolyte solution, the aqueous electrolyte solution is difficult to be electrolyzed. The form of the anode current collector layer 30 is not specifically restricted, and may have any form such as foil, mesh, and a porous form. The anode current collector layer 30 may be one, a surface of a base material of which is plated with metal as described above, or on the surface of the base material of which metal as described above is deposited.

A surface of the anode current collector layer 30 may be coated with a carbon material in the aqueous potassium-ion battery 1000 of the present disclosure. That is, in the aqueous potassium-ion battery 1000 of the present disclosure, the anode 200 may comprise the anode current collector layer 30, and a covering layer that is provided for one surface of the anode current collector layer 30, the surface being on a side where the aqueous electrolyte solution 50 is arranged (between the anode current collector layer 30 and the anode active material layer 40), and the covering layer may contain a carbon material. Examples of a carbon material include Ketjenblack (KB), vapor grown carbon fiber (VGCF), acetylene black (AB), carbon nanotubes (CNT), carbon nanofiber (CNF), carbon black, coke and graphite. The thickness of the covering layer is not specifically limited. The covering layer may be provided for either all over or part of the surface of the anode current collector layer 30. The covering layer may contain a binder for binding carbon materials each other, and for binding a carbon material to the anode current collector layer 30. According to new findings of the inventor of the present disclosure, when the covering layer containing a carbon material is provided for the surface of the anode current collector layer 30, the withstanding voltage of the aqueous electrolyte solution on the reduction side becomes high.

Generally, a work function of a carbon material is as high as approximately 5 eV. When a surface of an anode current collector layer is coated with a carbon material, an aqueous electrolyte solution is easy to be electrolyzed when a battery is charged/discharged (a potential window of an aqueous electrolyte solution on the reduction side is easy to narrow). More specifically, since there is a tendency of a high work function along an edge portion but a low work function on a flat portion in a carbon material, an aqueous electrolyte solution is easy to be electrolyzed along an edge portion priorly. On the other hand, in the aqueous electrolyte solution of the present disclosure, potassium pyrophosphate is dissolved so as to have a concentration of no less than 2 mol/kg, and it is believed that according to the mechanism described above, a pyrophosphate ion decomposes to form a coating on a surface of the anode 200 when the battery is charged. According to findings of the inventor of the present disclosure, this effect is also confirmed on a surface of a carbon material. Since an edge portion of a carbon material has a high reaction activity, it is believed that a pyrophosphate ion is easy to adsorb and decompose there, which makes it easy for a coating to accumulate there. Thus, according to the aqueous electrolyte solution of the present disclosure, it is believed that an edge portion of a carbon material is inactivated, which makes it possible to suppress electrolysis of the aqueous electrolyte solution along an edge portion, and as a result, the potential window of the aqueous electrolyte solution on the reduction side expands.

2.2.3. Anode Active Material Layer

The anode active material layer 40 contains the anode active material 41. The anode active material layer 40 may contain a conductive additive 42 and a binder 43 in addition to the anode active material 41.

The anode active material 41 may be selected in view of potential windows of the aqueous electrolyte solution. Examples thereof include potassium-transition metal complex oxides; titanium oxide; metallic sulfides such as Mo₆S₈; elemental sulfur; KTi₂(PO₄)₃; and NASICON-type compounds. Specifically, at least one titanium-containing oxide selected from potassium titanate and titanium oxide is more preferably contained. Only one of them may be individually used, or two or more of them may be mixed to be used as the anode active material 41.

The shape of the anode active material 41 is not specifically restricted. For example, a particulate shape is preferable. When the anode active material 41 is in the form of a particle, the primary particle size thereof is preferably 1 nm to 100 μm. The lower limit thereof is more preferably no less than 10 nm, further preferably no less than 50 nm, and especially preferably no less than 100 nm; and the upper limit is more preferably no more than 30 μm, and further preferably no more than 10 μm. Primary particles of the anode active material 41 one another may assemble to form a secondary particle. In this case, the secondary particle size is not specifically restricted, and is usually 0.5 μm to 100 μm. The lower limit is preferably no less than 1 μm, and the upper limit is preferably no more than 20 μm. The particle sizes of the anode active material 41 within these ranges make it possible to obtain the anode active material layer 40 further superior in ion conductivity and electron conductivity.

The amount of the anode active material 41 contained in the anode active material layer 40 is not specifically restricted. For example, on the basis of the whole of the anode active material layer 40 (100 mass %), the content of the anode active material 41 is preferably no less than 20 mass %, more preferably no less than 40 mass %, further preferably no less than 60 mass %, and especially preferably no less than 70 mass %. The upper limit is not specifically restricted, and is preferably no more than 99 mass %, more preferably no more than 97 mass %, and further preferably no more than 95 mass %. The content of the anode active material 41 within this range makes it possible to obtain the anode active material layer 40 further superior in ion conductivity and electron conductivity.

The anode active material layer 40 preferably contains the anode active material 41 and the conductive additive 42. Preferably, the anode active material layer 40 further contains the binder 43. The conductive additive 42 and the binder 43 are not specifically limited. For example, the conductive additive 42 and the binder 43 may be properly selected from the examples of the conductive additive 22 and the binder 23, to be used. The conductive additive 42 may be constituted of a material of a high work function (such as a carbon material). When such a conductive additive 42 of a high work function and an aqueous electrolyte solution are directly contacted with each other, electrolysis of this aqueous electrolyte solution is concerned. However, in the aqueous electrolyte solution 50 of this disclosure, potassium pyrophosphate is dissolved so as to have a concentration of no less than 2 mol/kg as described above, and a surface of the conductive additive 42 may be covered with a coating when the battery is charged, for example. That is, it is believed that even when a material of a high work function is used as the conductive additive 42, direct contact between the conductive additive 42 and the aqueous electrolyte solution can be suppressed, and electrolysis of the aqueous electrolyte solution on the surface of the conductive additive 42 can be suppressed. The amount of the conductive additive 42 contained in the anode active material layer 40 is not specifically restricted. For example, the content of the conductive additive 42 is preferably no less than 10 mass %, more preferably no less than 30 mass %, and further preferably no less than 50 mass %, on the basis of the whole of the anode active material layer 40 (100 mass %). The upper limit is not specifically restricted, and preferably no more than 90 mass %, more preferably no more than 70 mass %, and further preferably no more than 50 mass %. The content of the conductive additive 42 within this range makes it possible to obtain the anode active material layer 40 further superior in ion conductivity and electron conductivity. The amount of the binder 43 contained in the anode active material layer 40 is not specifically restricted. For example, the content of the binder 43 is preferably no less than 1 mass %, more preferably no less than 3 mass %, and further preferably no less than 5 mass %, on the basis of the whole of the anode active material layer 40 (100 mass %). The upper limit is not specifically restricted, and is preferably no more than 90 mass %, more preferably no more than 70 mass %, and further preferably no more than 50 mass %. The content of the binder 43 within this range makes it possible to properly bind the anode active material 41 etc., and to obtain the anode active material layer 40 further superior in ion conductivity and electron conductivity.

The thickness of the anode active material layer 40 is not specifically restricted, and for example, is preferably 0.1 μm to 1 mm, and is more preferably 1 μm to 100 μm.

2.3. Aqueous Electrolyte Solution

An electrolyte solution exists inside an anode active material layer, inside a cathode active material layer, and between the anode and cathode active material layers in a potassium-ion battery of an electrolyte solution system, which secures potassium ion conductivity between the anode and cathode active material layers. This embodiment is also employed for the battery 1000. Specifically, in the battery 1000, a separator 51 is provided between the cathode active material layer 20 and the anode active material layer 40. All the separator 51, the cathode active material layer 20, and the anode active material layer 40 are immersed in the aqueous electrolyte solution 50. The aqueous electrolyte solution 50 penetrates inside the cathode active material layer 20 and the anode active material layer 40.

The aqueous electrolyte solution 50 is the aqueous electrolyte solution of this disclosure. Detailed description thereof is omitted here.

2.4. Other Components

As described above, in the aqueous potassium-ion battery 1000, the separator 51 is preferably provided between the anode active material layer 20 and the cathode active material layer 40. A separator used in a conventional aqueous electrolyte solution battery (such as a nickel-metal hydride battery and a zinc-air battery) is preferably employed for the separator 51. For example, a hydrophilic one such as nonwoven fabric made of cellulose can be preferably used. The thickness of the separator 51 is not specifically restricted. For example, one having a thickness of 5 μm to 1 mm can be used.

The aqueous potassium-ion battery 1000 may include terminals, a battery case, etc. in addition to the components described above. Since these other components are obvious for the person skilled in the art who refers to the present application, description thereof is omitted here.

3. Method for Producing Aqueous Electrolyte Solution

The aqueous electrolyte solution can be produced by, for example, mixing water and K₄P₂O₇. Alternatively, the aqueous electrolyte solution can be produced by mixing water, a potassium ion source and a pyrophosphate ion source. A mixing means therefor is not specifically limited, and a known mixing means can be employed. Just filling a vessel with water and potassium pyrophosphate to be left to stand results in mixing with each other, and finally the aqueous electrolyte solution of the present disclosure is obtained.

4. Method for Producing Aqueous Potassium-Ion Battery

The aqueous potassium-ion battery 1000 can be produced via, for example, a step of producing the aqueous electrolyte solution 50, a step of producing the cathode 100, a step of producing the anode 200, and a step of storing the produced aqueous electrolyte solution 50, cathode 100, and anode 200 into the battery case.

4.1. Producing Aqueous Electrolyte Solution

The step of producing the aqueous electrolyte solution 50 is as described already. Detailed description thereof is omitted here.

4.2. Producing Cathode

The step of producing the cathode may be the same as a known step. For example, the cathode active material etc. to constitute the cathode active material layer 20 are dispersed in solvent, and a cathode mixture paste (slurry) is obtained. Water or any organic solvent can be used as the solvent used in this case without specific restrictions. A surface of the cathode current collector layer 10 is coated with the cathode mixture paste (slurry) using a doctor blade or the like, and thereafter dried, to form the cathode active material layer 20 over the surface of the cathode current collector layer 10, to be the cathode 100. Electrostatic spray deposition, dip coating, spray coating, or the like can be employed as well for the coating method other than a doctor blade method.

4.3. Producing Anode

The step of producing the anode may be the same as a known step. For example, the anode active material etc. to constitute the anode active material layer 40 are dispersed in solvent, and an anode mixture paste (slurry) is obtained. Water or any organic solvent can be used as the solvent used in this case without specific restrictions. The surface of the anode current collector layer 30 is coated with the anode mixture paste (slurry) using a doctor blade or the like, and thereafter dried, to form the anode active material layer 40 over the surface of the anode current collector layer 30, to be the anode 200. Electrostatic spray deposition, dip coating, spray coating, or the like can be employed as well for the coating method other than a doctor blade method.

4.4. Storing in Battery Case

The produced aqueous electrolyte solution 50, cathode 100, and anode 200 are stored in the battery case, to be the aqueous potassium-ion battery 1000. For example, the separator 51 is sandwiched between the cathode 100 and the anode 200, and a stack including the cathode current collector layer 10, the cathode active material layer 20, the separator 51, the anode active material layer 40, and the anode current collector layer 30 in this order is obtained. The stack is equipped with other members such as terminals if necessary. The stack is stored in the battery case, and the battery case is filled with the aqueous electrolyte solution 50. The stack and the electrolyte solution are sealed up in the battery case such that the stack is immersed in the aqueous electrolyte solution 50, which makes it possible to make the aqueous potassium-ion battery 1000.

### EXAMPLES

### 1. Examination of Electrolytes

Various potassium salts were dissolved in water, to make various aqueous electrolyte solutions. Each of these aqueous electrolyte solutions was subjected to cyclic voltammetry to, for example, measure a potential window thereof. The made aqueous electrolyte solutions were used after they had been put in a constant temperature oven at 25° C. no less than 3 hours before evaluation to adjust their temperatures to be stable.

### 1.1. Producing Aqueous Electrolyte Solution

### Comparative Example

In 1 kg of pure water, K₃Po₄ was dissolved so as to have a predetermined concentration, to obtain an aqueous electrolyte solution according to Comparative Example.

### Example

In 1 kg of pure water, K₄P₂O₇ was dissolved so as to have a predetermined concentration, to obtain an aqueous electrolyte solution according to Example.

### Reference Example

In 1 kg of pure water, 28 mol of CH₃COOK was dissolved, to obtain an aqueous electrolyte solution according to Reference Example.

### 1.2. Making Cell for Evaluating Potential Window

Ti was used for a working electrode, and a stainless steel plate on which Au was deposited (spacer of a coin battery) was used as a counter electrode. They were assembled in an opposing cell whose opening diameter was 10 mm (distance between the electrode plates: approximately 9 mm). Ag/AgCl (by Intakemi-sya) was used for a reference electrode. The cell was filled with an aqueous electrolyte solution described above (approximately 2 cc), to make an evaluation cell.

### 1.3. Evaluation Conditions

### 1.3.1. Potential Window

Potential windows of the aqueous electrolyte solutions were measured by means of the following electrochemical measuring device and constant temperature oven under the following measurement conditions. Each of potential windows of the reduction and oxidation sides was measured using different cells.

Electrochemical measuring device: VMP3 (manufactured by Bio-Logic Science Instruments SAS)

Constant temperature oven: LU-124 (manufactured by Espec Corp.)

Measurement conditions: cyclic voltammetry (CV), 1 mV/s, 25° C.

Specifically, the potential was started to be swept in each direction from OCP. The sweeping range was extended step by step to −0.8, −0.9, −1.0, −1.1, −1.2, −1.3, −1.4, −1.5 and −1.7 V (vs. Ag/AgCl) on the reduction side, and to 0.5, 0.7, 0.9, 1.1, 1.3, 1.5, 1.6, 1.7, 1.8, 1.9 and 2.0 V (vs. Ag/AgCl) on the oxidation side. Evaluation was carried out by 2 cycles. A potential at which a decomposition reaction started (a potential before a point at which a faradaic current started to be generated) was read from a graph of the first cycle within a sweeping range in which a faradaic current of 0.1 mA to 1 mA was observed, to define a potential window of an aqueous electrolyte solution.

### 1.3.2. Specific Gravity

Specific gravity of the aqueous electrolyte solutions was measured at 25° C. by means of a densimeter (manufactured by AS ONE Corporation).

### 1.3.3. Ion Conductivity

Ion conductivity of the aqueous electrolyte solutions was measured at 25° C. by means of an ion conductivity measurement device (Seven Multi manufactured by Metler Toledo).

### 1.3.4 Viscosity

Viscosity of the aqueous electrolyte solutions was measured at 25° C. by means of a viscosity measurement device (VISCOMATE VM-10A manufactured by SEKONIC CORPORATION).

### 1.3.5. pH

pH of the aqueous electrolyte solutions was measured at 25° C. by means of a pH meter (D51 manufactured by Horiba, Ltd.).

### 1.4 Evaluation Results

### 1.4.1. Properties of Aqueous Electrolyte Solutions According to Example and Comparative Example

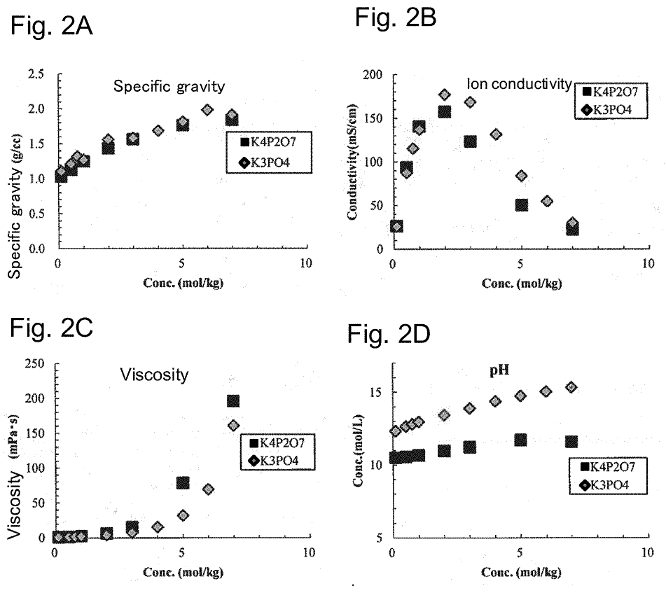

FIGS. 2A to 2D show the relationship between the concentrations and specific gravity (FIG. 2A), the relationship between the concentrations and ion conductivity (FIG. 2B), the relationship between the concentrations and viscosity (FIG. 2C), and the relationship between the concentrations and pH (FIG. 2D) of the aqueous electrolyte solution according to Example where K₄P₂O₇ was dissolved, and that according to Comparative Example where K₃PO₄ was dissolved. As shown in FIGS. 2A to 2D, properties of the electrolyte solution in the case where K₄P₂O₇ was dissolved are similar to those in the case where K₃PO₄ was dissolved except pH. As shown in FIG. 2B, the ion conductivity of the aqueous electrolyte solutions is the highest at 2 mol/kg in concentration, and lowers at concentrations of no less than 2 mol/kg. This seems to have been because of progress of formation of associations in addition to influence of high viscosity. That is, it is believed that cations and anions were close to each other to form associations when the concentrations were no less than 2 mol/kg in the aqueous electrolyte solutions of Example and Comparative Example while having dissociated and having been dissolved completely at low concentrations therein.

### 1.4.2. Potential Windows of Aqueous Electrolyte Solutions of Example and Comparative Example

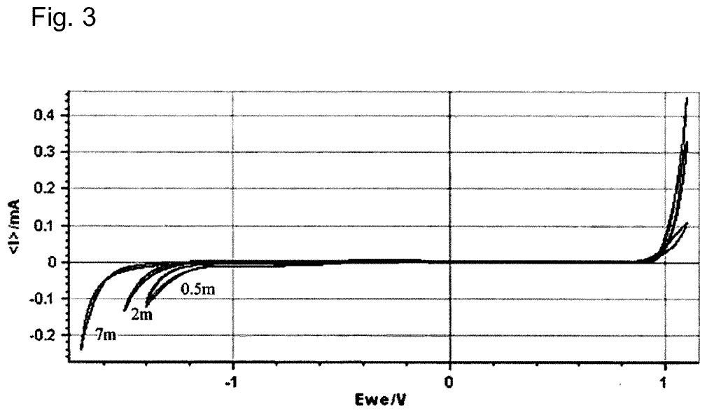

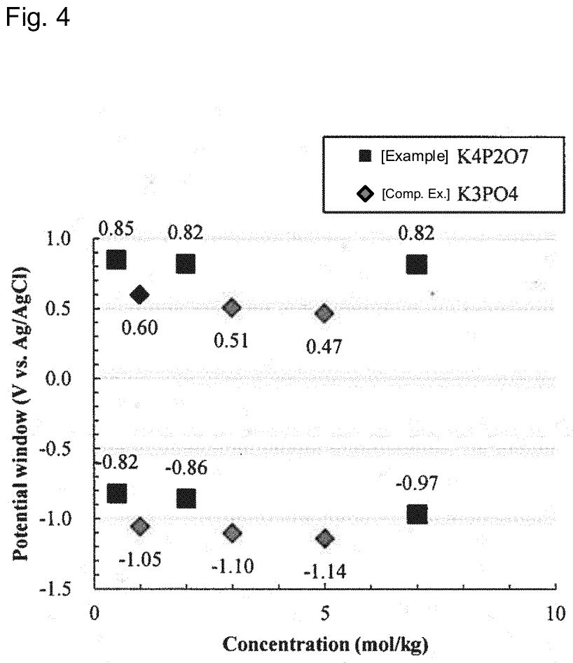

The following Table 1 shows the relationship between the concentrations and potential windows of the aqueous electrolyte solution of Example. FIG. 3 is a cyclic voltammogram of the aqueous electrolyte solution of Example (concentration of K₄P₂O₇: 0.5 mol/kg, 2 mol/kg and 7 mol/kg) on both the oxidation and reduction sides. Further, FIG. 4 shows the relationship between the concentrations and potential windows of the aqueous electrolyte solutions of Example and Comparative Example. The results shown in FIG. 4 are results when a Au depositing stainless steel plate was used as the working electrode instead of Ti.

TABLE 1

| | Concentration | | | |
|---|---|---|---|---|
| | of K₄P₂O₇ | Potential window V vs. Ag/AgCl | | |
| | mol/kg | Reduction side | Oxidation side | Total |
| Ex. | 0.5 | −1.05 | 0.87 | 1.92 |
| | 1 | −1.05 | — | — |
| | 2 | −1.09 | 0.87 | 1.96 |
| | 3 | −1.14 | — | — |
| | 5 | −1.19 | — | — |
| | 7 | −1.21 | 0.83 | 2.04 |

As is clear from the results shown in FIGS. 2A to 4 and Table 1, the potential window of the aqueous electrolyte solution of Example on the reduction side largely expanded at concentrations of 2 mol/kg, which was the peak top of the ion conductivity, and higher. As described above, it is believed that the proportion of associations in an electrolyte solution increases at a concentration of no less than 2 mol/kg, whereby it seems that anions in the electrolyte solution (pyrophosphate ion) was drown to an anode together with cations (potassium ion), and reduction decomposition occurred on a surface of the anode, to form a coating on the surface of the anode. As a result, it is believed that direct contact between the electrolyte solution and a portion of a high work function on the surface of the anode was suppressed, electrolysis of the electrolyte solution on the surface of the anode was suppressed, and the potential window on the reduction side expanded.

On the other hand, the potential window of the aqueous electrolyte solution of Comparative Example on the reduction side also expanded as the concentration of K₃PO₄ increased. However, in the aqueous electrolyte solution of Comparative Example, pH of the electrolyte solution was too high as the concentration of K₃PO₄ increased, which resulted in a narrow potential window on the oxidation side.

### 1.4.3. Potential Windows of Aqueous Electrolyte Solutions of Example and Reference Example

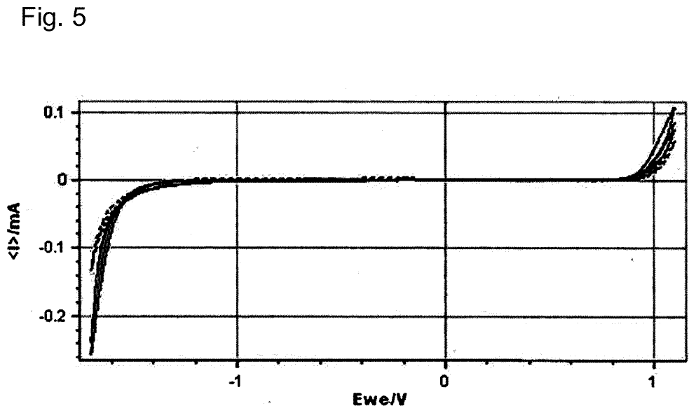

FIG. 5 is a cyclic voltammogram of the aqueous electrolyte solution of Example (concentration of K₄P₂O₇: 7 mol/kg) and that of Reference Example (concentration of CH₃COOK: 28 mol/kg) on both the oxidation and reduction sides. As is clear from the results shown in FIG. 5, the aqueous electrolyte solution of Example had a potential window almost equivalent to that of Reference Example although the concentration of the electrolyte of Example was lowered much more than that of Reference Example.

### 2. Examination of Type of Anode Current Collector

When a material of a high work function is employed for an anode current collector in an aqueous battery, it is believed that the aqueous electrolyte solution is easily electrolyzed on a surface of the anode current collector, and a potential window of the aqueous electrolyte solution on the reduction side narrows. It seems to be effective to compose an anode current collector by using a material of a low work function in order to suppress electrolysis of an aqueous electrolyte solution on a surface of an anode in an aqueous battery. Examples of a material of a low work function include Al, Ti, Pb, Zn, Sn, Mg, Zr and In. However, the inventor of the present application found that the combination of an aqueous electrolyte solution in which potassium pyrophosphate is dissolved and a carbon material, which is generally known as a material of a high work function, causes behavior deviated from a tendency as described above, which will be described as follows with Example.

### 2.1. Making Aqueous Electrolyte Solution

### 2.1.1. Example

In 1 kg of pure water, K₄P₂O₇ was dissolved so as to have a predetermined concentration (0.5 mol/kg, 2 mol/kg or 7 mol/kg), to obtain an aqueous electrolyte solution according to Example.

### 2.1.2. Comparative Example

In 1 kg of pure water, 21 mol of LiTFSI was dissolved, to obtain an aqueous electrolyte solution according to Comparative Example.

### 2.2. Making Carbon-Coating Ti Electrode

Acetylene black (AB manufactured by Hitachi Chemical Company, Ltd.) and PVdF (manufactured by KUREHA CORPORATION) were weighed so as to have a mass ratio of AB:PVdF=92.5:7.5, and mixed in a mortar. While the viscosity was confirmed, NMP was added thereto. After continued to be mixed in the mortar to be uniform, they were put into a container, and mixed by means of a mixer (Thinker mixer (Awatori rentaro) manufactured by Thinky Corporation) at 3000 rpm for 10 minutes, to obtain a slurry. The obtained slurry was put on Ti foil, and the foil was coated therewith by means of a doctor blade to form a covering layer containing a carbon material over a surface of the Ti foil, to be a carbon-coating Ti electrode.

### 2.3. Making Cell for Evaluating Potential Window

Au, Ti or the carbon-coating Ti electrode was used as a working electrode, and a stainless steel plate on which Au was deposited (spacer of a coin battery) was used as a counter electrode. They were assembled in an opposing cell whose opening diameter was 10 mm (distance between the electrode plates: approximately 9 mm). Ag/AgCl (by Intakemi-sya) was used for a reference electrode. The cell was filled with an aqueous electrolyte solution described above (approximately 2 cc), to make an evaluation cell.

### 2.4. Evaluation Conditions

Potential windows of the aqueous electrolyte solutions on the reduction side were measured using the following electrochemical measuring device and constant temperature oven under the following measurement conditions.

Electrochemical measuring device: VMP3 (manufactured by Bio-Logic Science Instruments SAS)

Constant temperature oven: LU-124 (manufactured by Espec Corp.)

Measurement conditions: cyclic voltammetry (CV), 1 mV/s, 25° C.

Specifically, the potential was started to be swept in each direction from OCP. The sweeping range was extended step by step to −0.8, −0.9, −1.0, −1.1, −1.2, −1.3, −1.4, −1.5 and −1.7 V (vs. Ag/AgCl). Evaluation was carried out by 2 cycles. A potential at which a reduction reaction started (potential before a point at which a faradaic current started to be generated) was read from a graph of the first cycle within a sweeping range in which a faradaic current of 0.1 mA to 1 mA was observed, to define a potential window of an aqueous electrolyte solution on the reduction side.

### 2.5. Evaluation Results

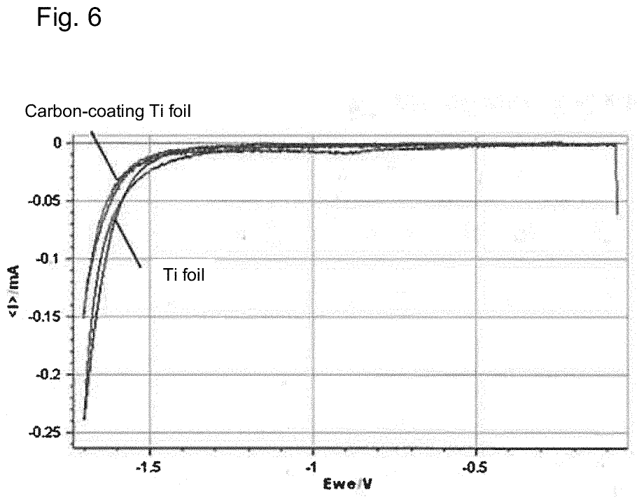

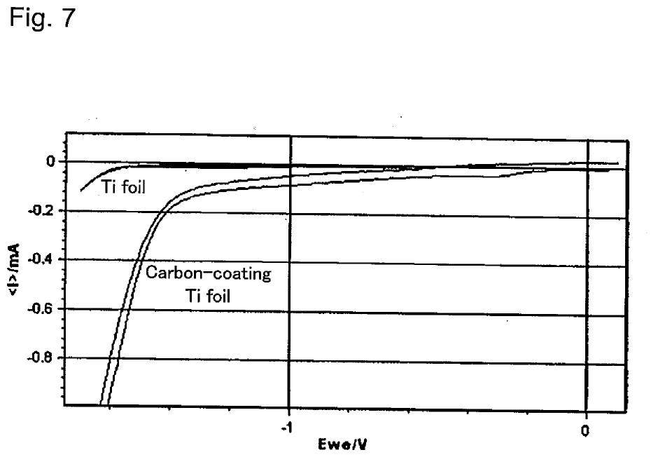

The following Table 2 shows the relationship between the concentrations of the aqueous electrolyte solution, types of the working electrode, and potential windows of the aqueous electrolyte solution according to Example. FIG. 6 is a cyclic voltammogram of the aqueous electrolyte solution of Example (concentration of K₄P₂O₇: 7 mol/kg) on the reduction side in both cases where Ti was used for the working electrode and where the carbon-coating Ti electrode was used as the working electrode. The following Table 3 shows the relationship between types of the working electrode and potential windows of the aqueous electrolyte solution according to Comparative Example. FIG. 7 is a cyclic voltammogram of the aqueous electrolyte solution of Comparative Example (concentration of LiTFSI: 21 mol/kg) on the reduction side in both cases where Ti was used for the working electrode and where the carbon-coating Ti electrode was used as the working electrode.

TABLE 2

| | | | | Potential |
|---|---|---|---|---|
| | Concentration | | Work function of | window |
| | of K₄P₂O₇ | Working | working electrode | V vs. Ag/AgCl |
| | mol/kg | electrode | eV | Reduction side |
| Ex. | 0.5 | Au | 5.1 | −0.82 |
| | 2 | | | −0.86 |
| | 7 | | | −0.97 |
| | 0.5 | Carbon-coating | 5 | −1.01 |
| | 2 | Ti | | −1.09 |
| | 7 | | | −1.36 |
| | 0.5 | Ti | 4.33 | −1.03 |
| | 2 | | | −1.06 |
| | 7 | | | −1.20 |

TABLE 3

| | | | | Potential |
|---|---|---|---|---|
| | Concentration | | Work function of | window |
| | of LiTFSI | Working | working electrode | V vs. Ag/AgCl |
| | mol/kg | electrode | eV | Reduction side |
| Comp. | 0.5 | Au | 5.1 | −0.91 |
| Ex. | 0.5 | Carbon- | 5 | −1.20 |
| | | coating | | |
| | | Ti | | |
| | 0.5 | Ti | 4.33 | −1.50 |

As is clear from the results shown in Table 3 and FIG. 7, reduction decomposition was easy to occur on a surface of an electrode of a high work function in the aqueous electrolyte solution in which a conventional electrolyte like LiTFSI was dissolved, and the higher a work function of the electrode was, the narrower the potential window of the aqueous electrolyte solution on the reduction side was.

In contrast, as is clear from the results shown in Table 2 and FIG. 6, the aqueous electrolyte solution according to Example, where K₄P₂O₇ was used as an electrolyte, displayed behavior different from a conventional aqueous electrolyte solution. That is, when the concentration of K₄P₂O₇ in the aqueous electrolyte solution was no less than 2 mol/kg, the potential window on the reduction side expanded more in a case where carbon-coating Ti of a high work function was used for the electrode than in a case where Ti of a low work function was used for the electrode. This is presumed to have been according to the following mechanism.

Since there is a tendency of a high work function along an edge portion but a low work function on a flat portion in a carbon material, an aqueous electrolyte solution is easy to be electrolyzed along an edge portion priorly. Here, since an edge portion of a carbon material has a high reaction activity, it is believed that a pyrophosphate ion is easy to adsorb and decompose there, which makes it easy for a coating to accumulate there. Thus, when the aqueous electrolyte solution of Example was used, it is believed that an edge portion of a carbon material was inactivated, which made it possible to suppress electrolysis of the aqueous electrolyte solution along an edge portion, and as a result, the potential window of the aqueous electrolyte solution on the reduction side expanded.

### 3. Addition

The Example shows adding K₄P₂O₇ to water, to make the aqueous electrolyte solution. The aqueous electrolyte solution of the present disclosure is not limited to this Example. The same effect is also brought about if a potassium ion source (such as KOH and CH₃COOK) and a pyrophosphate ion source (such as H₄P₂O₇) are separately added to and dissolved in water.

Aqueous electrolyte solutions for sodium-ion batteries which contain NaClO₄ and NaFSI are known as prior arts (Electrochemistry, 2017, 85, 179 and ACS Energy Lett., 2017, 2, 2005). However, when a perchlorate such as NaClO₄ is used, there is a concern for safety. In addition, while an imide salt such as NaFSI is expensive and thus the amount of adding an imide salt to an electrolyte solution has to be as small as possible, a potential window of an electrolyte solution cannot be expanded sufficiently if the amount of adding an imide salt is reduced. An aqueous electrolyte solution for potassium-ion batteries which contains CH₃COOK is also known as a prior art (ACS Energy Lett., 2018, 3, 373). However, in this case, CH₃COOK has to be dissolved so as to have an extremely high concentration such as 30 mol/kg in order to expand a potential window of an aqueous electrolyte solution, which is not realistic. In contrast, in the aqueous electrolyte solution of the present disclosure, only dissolving potassium pyrophosphate so as to have such a concentration as to be realistic for practical use makes it possible to largely expand a potential window.

### INDUSTRIAL APPLICABILITY

An aqueous potassium-ion battery using the aqueous electrolyte solution of this disclosure can be used in a wide range of power sources such as an onboard large-sized power source and a small-sized power source for portable terminals.

### REFERENCE SIGNS LIST

10 cathode current collector layer
20 cathode active material layer
21 cathode active material
22 conductive additive
23 binder
30 anode current collector layer
40 anode active material layer
41 anode active material
42 conductive additive
43 binder
50 aqueous electrolyte solution
51 separator
100 cathode
200 anode
1000 aqueous potassium-ion battery

1. An aqueous electrolyte solution that is used for an aqueous potassium-ion battery, the aqueous electrolyte solution comprising:
water; and
potassium pyrophosphate that is dissolved in the water so that a concentration thereof per kilogram of the water is no less than 2 mol.

2. The aqueous electrolyte solution according to claim 1, wherein
the potassium pyrophosphate is dissolved in the water so that the concentration per kilogram of the water is no more than 7 mol.

3. The aqueous electrolyte solution according to claim 1, wherein pH is no more than 13.

4. An aqueous potassium-ion battery comprising:
the aqueous electrolyte solution according to claim 1;
a cathode that is in contact with the aqueous electrolyte solution; and
an anode that is in contact with the aqueous electrolyte solution.

5. The aqueous potassium-ion battery according to claim 4, wherein
the anode comprises an anode current collector layer, and a covering layer that is provided for one surface of the anode current collector layer, the surface being on a side where the aqueous electrolyte solution is arranged, and
the covering layer contains a carbon material.

6. The aqueous potassium-ion battery according to claim 4, wherein the anode comprises an anode current collector layer that contains Ti.
